(19) United States
(12) Patent Application Publication
(10) Pub. No.: US 2012/0090814 A1
(43) Pub. Date: Apr. 19, 2012

(54) VEHICLE HVAC SYSTEM

(76) Inventors: Andrew D. Crosier, Canton, MI (US); Wayne Wright, Clarkston, MI (US); Dale Acton, Davison, MI (US); Calogero Alu, Shelby Township, MI (US)

(21) Appl. No.: 13/242,275

(22) Filed: Sep. 23, 2011

Related U.S. Application Data
(60) Provisional application No. 61/392,704, filed on Oct. 13, 2010.

(51) Int. Cl. B60H 1/00; B60H 1/34; F24F 7/007

(52) U.S. Cl. 165/59; 454/143; 454/152

(57) ABSTRACT

A vehicle HVAC system includes a first air handling module having a blower motor assembly that includes a fan that reverses direction to selectively extract airflow from a vehicle cabin into the first air handling module and communicate a conditioned airflow from the first air handling module into the vehicle cabin.

### CROSS-REFERENCE TO RELATED APPLICATIONS

This application claims priority to U.S. Provisional Application No. 61/392,704, filed Oct. 13, 2010.

### BACKGROUND

This disclosure relates to a heating, ventilation and air conditioning (HVAC) system, and more particularly to a vehicle HVAC system.

Modern day motor vehicles typically include HVAC systems that maintain a climate of a vehicle cabin interior. Such HVAC systems provide the necessary heating, ventilation and air conditioning to the vehicle cabin. HVAC systems include a network of ducts and vents for transferring airflow throughout the vehicle cabin to condition the vehicle cabin to a desired occupant selected temperature.

HVAC systems typically include an air handling module having one or more actuating doors for opening and closing selected ducts and vents that define multiple airflow paths of the HVAC system. For example, the HVAC system may be operable in both a recirculation mode and fresh air mode. To operate a typical HVAC system in the recirculation mode, a recirculation door closes the fresh air inlet enabling the HVAC system to draw air from the vehicle interior. To operate in various other modes, such as panel, defrost, and floor modes, similar doors and linkages are utilized.

### SUMMARY

A vehicle HVAC system includes a first air handling module having a fan that reverses direction to selectively extract airflow from a vehicle cabin into the first air handling module and communicate a conditioned airflow from the first air handling module into the vehicle cabin.

In another exemplary embodiment, a vehicle HVAC system includes an air handling module having a housing, a blower motor assembly, a heating element and a cooling element. The heating element and the cooling element are disposed within the housing. The air handling module defines a single air passageway through the housing, the heating element and the cooling element.

In yet another exemplary embodiment, a method of providing a vehicle HVAC system includes operating the vehicle HVAC system in a cooling mode and a heating mode. In the cooling mode, airflow is extracted from a vehicle cabin through a first plurality of vents and is conditioned. The conditioned airflow is then communicated through a second plurality of vents into the vehicle cabin. In the heating mode, airflow is extracted from the vehicle cabin through the second plurality of vents and is conditioned. The conditioned airflow is communicated through the first plurality of vents and into the vehicle cabin.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a vehicle having an HVAC system.

FIG. 2 illustrates an example HVAC system.

FIGS. 3A and 3B illustrate example positions of air handling modules within a vehicle.

FIGS. 4A and 4B illustrate an example air handling module of the HVAC system of FIG. 2.

FIG. 5 illustrates another example air handling module.

FIGS. 6A and 6B schematically illustrate heating and cooling modes of an HVAC system.

### DETAILED DESCRIPTION

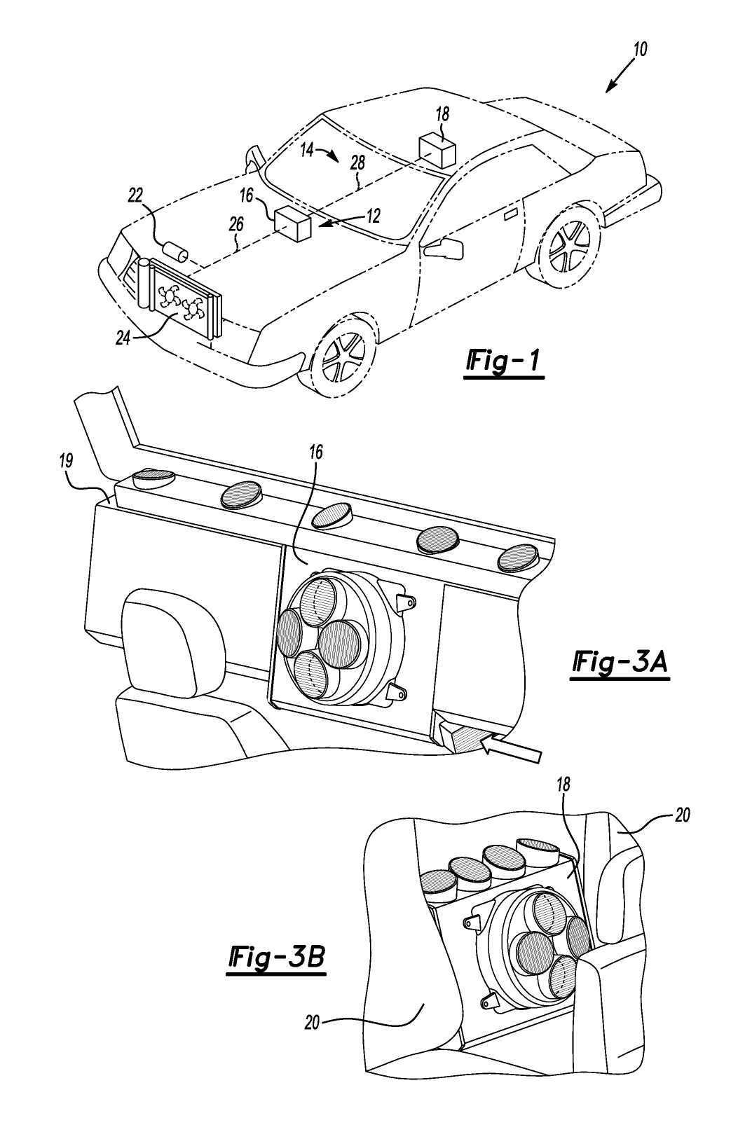

FIG. 1 illustrates a vehicle 10 having a heating, ventilation and air conditioning (HVAC) system 12. The vehicle 10 can include any vehicle for any application. The HVAC system 12 generally provides heating, ventilation and air conditioning to a vehicle cabin 14 of the vehicle 10. For example, the HVAC system 12 can communicate a conditioned airflow (i.e., a heated or cooled airflow) within the vehicle cabin 14 to achieve a desired comfort level (as selected by a vehicle occupant) within the vehicle cabin 14.

The HVAC system 12 can include a first air handling module 16 and a second air handling module 18 that is separate from the first air handling module 16. The air handling modules 16, 18 provide conditioned airflows to separate locations (i.e., separate zones) of the vehicle 10, such as the front and rear of the vehicle 10.

The HVAC system 12 further includes a compressor 22 and a condenser assembly 24. During operation, the compressor 22 compresses a refrigerant fluid to a high pressure and high temperature. The high pressure and high temperature refrigerant fluid is communicated from the compressor 22 to the condenser assembly 24. The refrigerant fluid loses heat to the atmosphere in the condenser assembly 24. The condenser assembly 24 cools and condenses the refrigerant fluid by exchanging heat with outside air. The compressor 22 and the condenser assembly 24 are in fluid communication with the first air handling module 16 via a conduit 26. The first air handling module 16 is in fluid communication with the second air handling module 18 via a conduit 28.

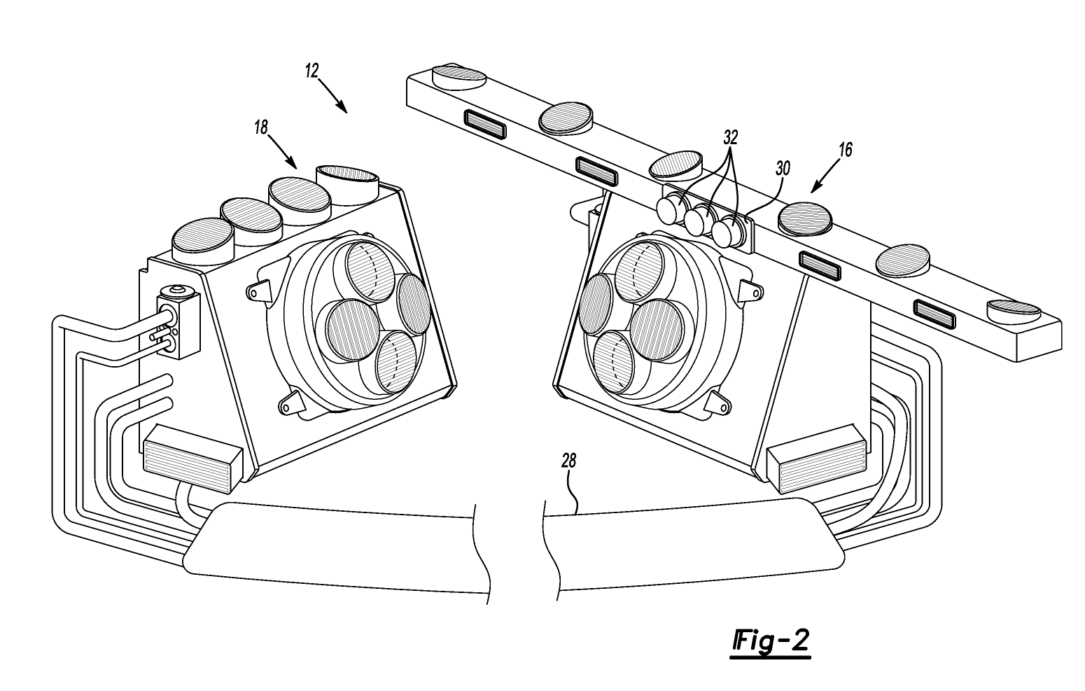

FIG. 2 (with continued reference to FIG. 1) illustrates an example HVAC system 12 that can be incorporated into the vehicle 10. The HVAC system 12 includes a first air handling module 16 and a second air handling module 18 in fluid communication with the first air handling module 16. The first and second air handling modules 16, 18 are not necessarily shown to the scale or positioning they would be in practice, but are instead shown schematically to better illustrate their features.

A conduit 28 extends between the first air handling module 16 and the second air handling module 18. The conduit 28 can include any refrigerant lines, coolant hoses, drain hoses, wiring harnesses or other connections necessary to fluidly connect the first air handling module 16 and the second air handling module 18. The first air handling module 16 and the second air handling module 18 can be substantially identical, although not necessary. In other words, the first air handling module 16 and the second air handling module 18 can include identical parts and components for complexity reduction, as is further disclosed below.

At least one (or both) of the first air handling module 16 and the second air handling module 18 includes a control unit 30. The control unit 30 includes the necessary integral logic to control the operability of the first air handling module 16 and the second air handling module 18 for delivering conditioned airflow into the vehicle cabin 14. The control unit 30 can include a plurality of switches or toggles 32 that can be manipulated by a vehicle occupant to heat and/or cool the vehicle cabin 14. For example, the switches or toggles 32 can control fan speed, temperature, mode or other HVAC system parameters.

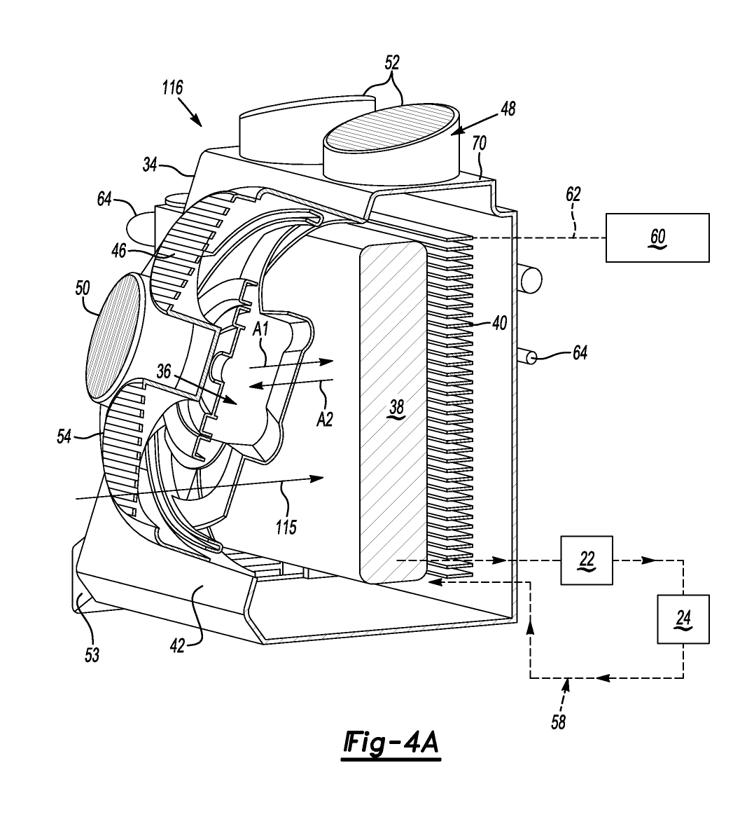

In this example, the first air handling module 16 is disposed toward a front of the vehicle 10 to provide conditioned airflow to the vehicle occupant(s) seated in the front seats of the vehicle 10, while the second air handling module 18 is disposed toward the rear of the vehicle 10 to provide conditioned airflow to the vehicle occupant(s) seated in the rear of the vehicle 10. For example, the air handling module 16 can be disposed at and/or incorporated into the vehicle dashboard 19 (see FIG. 3A) and the second air handling module 18 can be positioned between rear seats 20 of the vehicle 10 (see FIG. 3B). Other mounting locations are also contemplated, and any number of air handling modules can be incorporated into the HVAC system 12.

In one example, the HVAC system 12 operates only in an air recirculation mode in which airflow can be continuously recirculated through the vehicle cabin 14 via the first and second air handling modules 16, 18. Other systems, such as a fresh air system, can be incorporated as peripheral systems.

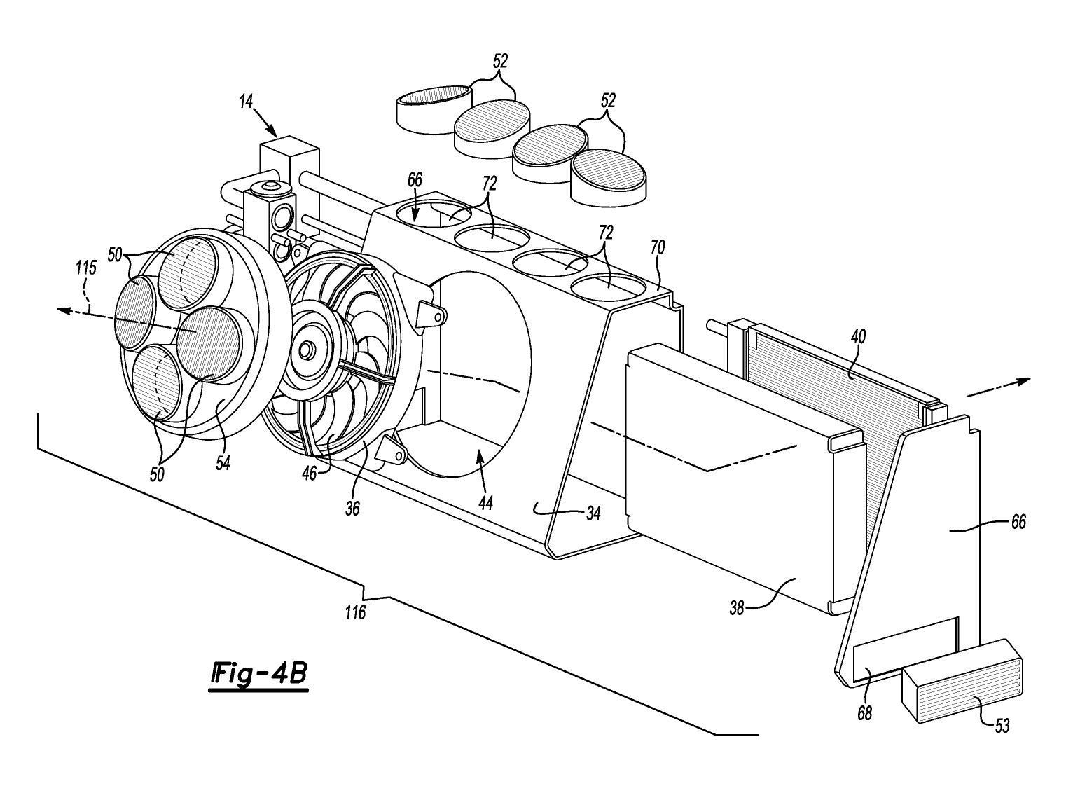

FIGS. 4A and 4B illustrate an example air handling module 116 that could be exemplary of either the first air handling module 16 or the second air handling module 18. The air handling module 116 includes a housing 34, a blower motor assembly 36, a cooling element 38 (such as an evaporator) and a heating element 40 (such as a heater core). The cooling element 38 and the heating element 40 are substantially enclosed by the housing 34. The blower motor assembly 36 can be mounted to a front face 42 of the housing 34 and is disposed relative to an opening 44 (see FIG. 4B) through the front face 42. When assembled, the cooling element 38 can be positioned between the heating element 40 and the blower motor assembly 36, although other configurations are contemplated.

The air handling module 116 establishes a single air passageway 115 for communication of an airflow through the air handling module 116. In other words, airflow is communicated along a single path through the air handling module 116. The single air passageway 115 extends through the housing 34, the cooling element 38 and through the heating element 40. The air handling module 116 includes only a single moving part and is free of actuating parts except for the single moving part. For example, the single moving part includes a fan 46 of the blower motor assembly 36. In this disclosure, the term “actuating parts” includes gates, doors, flaps, actuators, shafts, vanes, cams or any other kinematic system. The air handling module 116 of this disclosure minimizes such actuating parts with the exception of the fan 46.

The fan 46 of the blower motor assembly 36 can include a reversible fan that is operable to both push airflow (in the direction of arrow A1) through the cooling element 38 and the heating element 40 or alternatively pull airflow in an opposite direction (indicated by arrow A2) through the heating element 40 and the cooling element 38 and out of the housing 34. In other words, the fan 46 can reverse direction to selectively extract air from the vehicle cabin 14 into the air handling module 116 and can also communicate a conditioned airflow from the air handling module 116 into the vehicle cabin 14, as is discussed in greater detail below. Any of a variety of fan designs can be incorporated into the air handling module 116.

The air handling module 116 can further include a first plurality of vents 48 and a second plurality of vents 50. The first and second plurality of vents 48, 50 can both receive and communicate airflow. In this example, the first plurality of vents 48 include a plurality of defrost vents 52 and multiple floor vents 53. The second plurality vents 50 are disposed on a duct front panel 54. However, other venting and ducting configurations are contemplated as within the scope of this disclosure. The duct front panel 54 is mounted to the blower motor assembly 36 at the front face 42 of the housing 34.

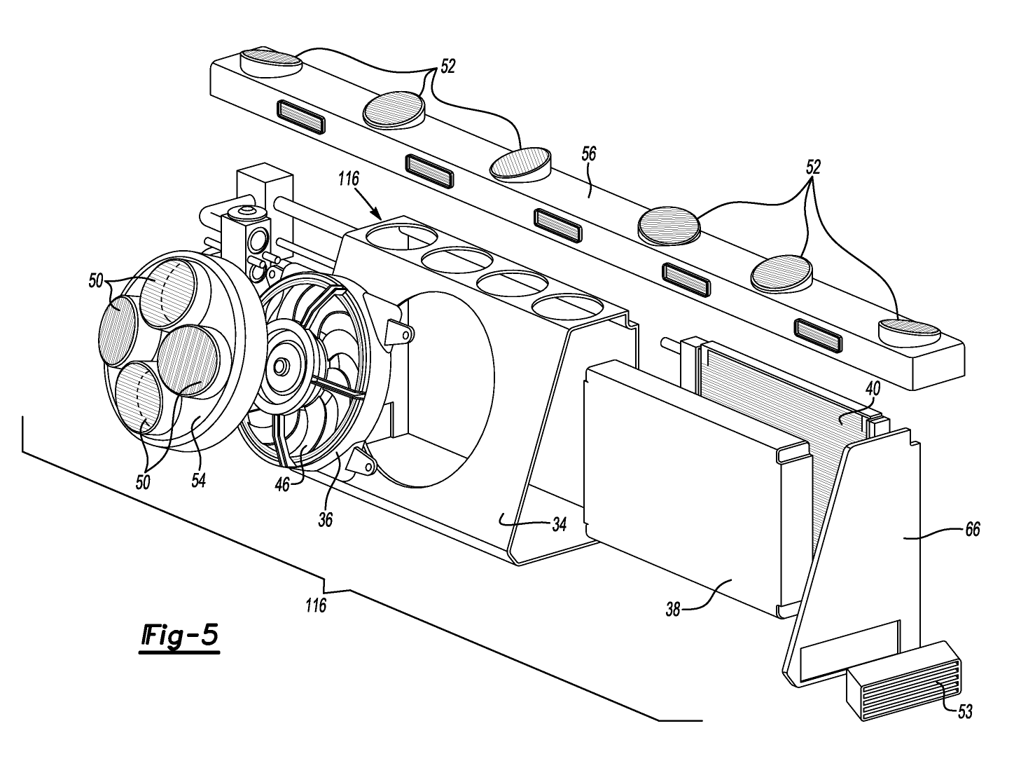

The first plurality of vents 48 of FIGS. 4A and 4B could include a plurality of individual defrost vents 52; however, in another embodiment depicted by FIG. 5, the air handling module 116 could include a defrost distribution duct 56 that includes a plurality of defrost vents 52. In combination, the first plurality vents 48 and the second plurality vents 50 extract airflow from the vehicle cabin 14 and distribute a conditioned airflow to various desired locations of the vehicle cabin 14.

Referring to FIG. 4A, the cooling element 38 of the handling module 116 is fluidly connected in a closed loop conduit 58. The cooling element 38 selectively receives a refrigerant fluid from the condenser assembly 24 (see also FIG. 1). The cooling element 38 absorbs heat from the airflow communicated from the fan 46 and exchanges the heat with the refrigerant fluid that is communicated through the cooling element 38 during powertrain operation. The refrigerant fluid is then returned to the compressor 22 and the cycle repeats when the vehicle occupant has selected a cooling mode of the HVAC system 12.

The heating element 40 (or heater core) selectively provides a heated airflow to the vehicle cabin 14 when a vehicle occupant wishes to raise a temperature within the vehicle cabin 14. The heating element 40 is in fluid communication with a heat source 60, such as an internal combustion or electrical powertrain, via a conduit 62. During powertrain operation, and when a heating mode has been selected by a vehicle occupant, the heating element 40 releases the thermal energy received from the heat source 60 into an airflow that is communicated through the heating element 40 to heat the vehicle cabin 14.

The air handling module 116 further includes a plumbing system 64 that fluidly connects the components of the handling module 116. A refrigerant fluid is communicated through the HVAC system 12. Close-out panels 66 of the housing 34 can be disposed on either side of the housing 34 to substantially encase the cooling element 38 and the heating element 40 within the housing 34. The close-out panels 66 can include a plurality of openings 68 that receive venting or the components of the plumbing system 64. In addition, a top face 70 of the housing 34 can include a plurality of openings 72 for communicating a conditioned airflow to the defrost vents 52.

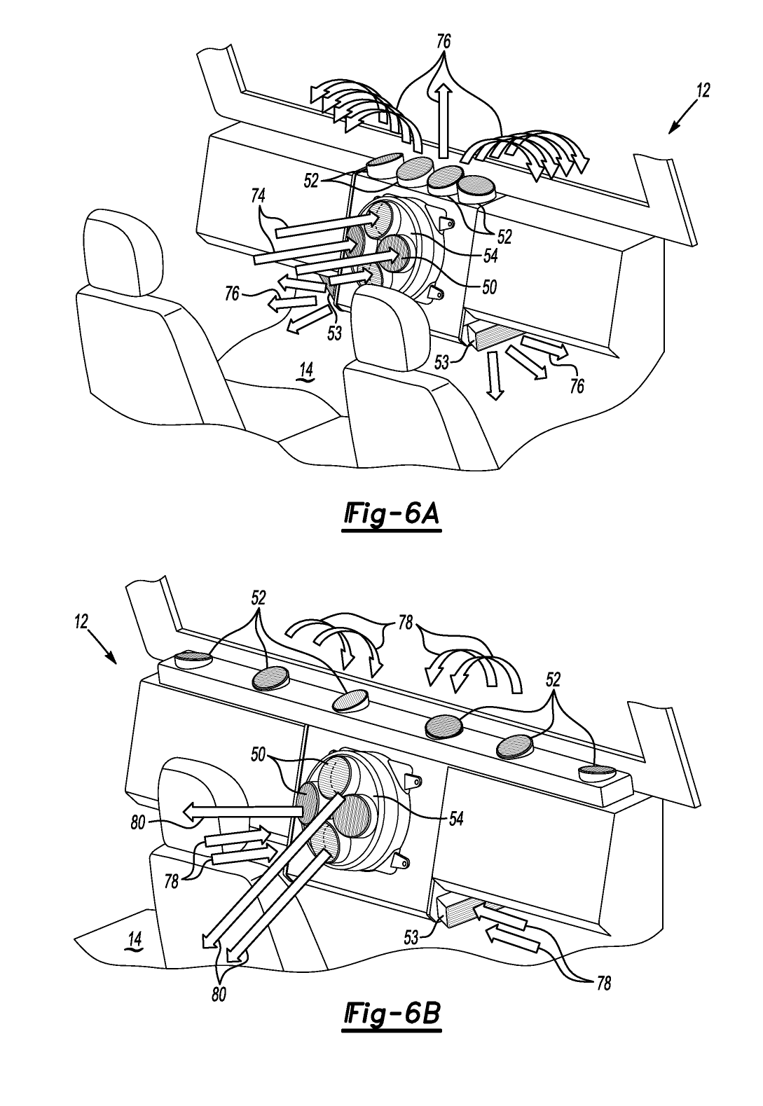

FIGS. 6A and 6B, with continued reference to FIGS. 1-5, illustrate operation of the HVAC system 12 in a heating mode and a cooling mode, respectively. The heating mode illustrated schematically by FIG. 6A is entered when a vehicle occupant chooses heat or defrost on a control unit 30 of the HVAC system 12. In the heating mode, the fan 46 of the blower motor assembly 36 extracts air (depicted by arrows 74) through the vents 50 of the duct front panel 54 and communicates the airflow through the cooling element 38 and the heating element 40. The airflow is conditioned by the heating element 40. The compressor 22 can be turned off during the heating mode such that refrigerant fluid is not communicated through the closed loop conduit 58 and the airflow is therefore not cooled even though it is communicated through the cooling element 38. A conditioned airflow (represented by arrows 76) is next communicated through the defrost vents 52 and the floor vents 53 to heat the vehicle cabin 14. An opposite configuration is also contemplated in which the airflow is extracted through the defrost vents 52 and the floor vents 53 and returned (after conditioning the airflow) through the vents 50. The fan 46 may be continuously variable between low and high speeds. Moreover, a second air handling module (not shown) can operate in the same manner to provide multiple zone heating.

Referring to FIG. 6B, the HVAC system 12 can also operate in a cooling mode to reduce a temperature of the vehicle cabin 14. A vehicle occupant chooses an air conditioning mode or cooling mode at the control unit 30 of the HVAC system 12. Airflow (depicted by arrows 78) is extracted from the vehicle cabin 14 through the defrost vents 52 and the floor vents 53. The airflow is communicated through the heating element 40 and the cooling element 38 and is conditioned by the cooling element 38 to cool the vehicle cabin 14. The conditioned airflow (depicted by arrows 80) is communicated out of the vents 50 of the duct front panel 54 and into the vehicle cabin 14 to condition the vehicle cabin 14.

As can be appreciated, the airflow is extracted from the vehicle cabin 14 in the cooling mode and is communicated back into the vehicle cabin 14 in the opposite vents from the heating mode to provide a simplified air circulation system. In the cooling mode, the heating element 40 may not receive fluid from the heat source 60 such that the heating element 40 cannot heat the airflow even though the airflow is still communicated through the heating element 40. The airflow that is communicated through the air handling module 116 is communicated through both the cooling element 38 and the heating element 40 in both the heating mode and the cooling mode.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle HVAC system, comprising:
an air handling module having a blower motor assembly that includes a fan that reverses direction to selectively extract an airflow from a vehicle cabin into said first air handling module and communicate a conditioned airflow from said first air handling module into said vehicle cabin.

2. The system as recited in claim 1, wherein said air handling module includes a cooling element and a heating element housed by a housing.

3. The system as recited in claim 1, comprising a first plurality of vents that receive said airflow and communicate said conditioned airflow.

4. The system as recited in claim 3, comprising a second plurality of vents that receive said airflow and communicate said conditioned airflow.

5. The system as recited in claim 1, comprising a control module that selectively controls said air handling module.

6. The system as recited in claim 1, wherein said air handling module establishes a single air passageway that communicates both of said airflow and said conditioned airflow.

7. A vehicle HVAC system, comprising:
an air handling module including:
a housing;
a blower motor assembly;
a heating element; and
a cooling element, wherein said heating element and said cooling element are disposed within said housing, and wherein said air handling module establishes a single air passageway through said housing, said heating element and said cooling element.

8. The system as recited in claim 7, wherein said air handling module includes a single moving part and is free of actuating parts except for said single moving part.

9. The system as recited in claim 8, wherein said single moving part is a fan of said blower motor assembly.

10. The system as recited in claim 8, wherein said single moving part is a reversible fan of said blower motor assembly.

11. The system as recited in claim 8, wherein said actuating parts include gates, doors and kinematic systems.

12. The system as recited in claim 7, wherein said cooling element is positioned between said blower motor assembly and said heating element within said housing.

13. The system as recited in claim 7, wherein an airflow is communicated through both of said cooling element and said heating element in either a heating mode or a cooling mode of the vehicle HVAC system.

14. A method of providing a vehicle HVAC system, comprising the steps of:
operating the vehicle HVAC system in a cooling mode including:
extracting airflow from a vehicle cabin through a first plurality of vents;
conditioning the airflow;
communicating a conditioned airflow through a second plurality of vents and into the vehicle cabin; and
operating the vehicle HVAC system in a heating mode including:
extracting airflow from the vehicle cabin through the second plurality of vents;
conditioning the airflow;
communicating a conditioned airflow through the first plurality of vents and into the vehicle cabin.

15. The method as recited in claim 14, wherein the airflow and the conditioned airflow of the heating mode and the cooling mode are communicated along a single air passageway.

16. The method as recited in claim 14, comprising the step of:
extracting and communicating both the airflow and the conditioned airflow with a reversible fan.

17. The method as recited in claim 14, comprising the step of:
communicating the airflow through both a cooling element and a heating element in both the heating mode and the cooling mode.
